(19) United States
(12) Patent Application Publication
(10) Pub. No.: US 2017/0014770 A1
(43) Pub. Date: Jan. 19, 2017

(54) SEAWATER DESALINATION DEVICE, METHOD FOR DESALINATING SEAWATER USING THE SAME, AND METHOD FOR CLEANING SEAWATER DESALINATION DEVICE

(71) Applicant: ROMER ENVIRONMENTAL PROTECTION (SHENZHEN) CO., LTD., Shenzhen (CN)

(72) Inventors: Guilin WANG, Shenzhen (CN); Wanzhang DONG, Shenzhen (CN)

(21) Appl. No.: 15/281,047

(22) Filed: Sep. 29, 2016

Related U.S. Application Data
(63) Continuation-in-part of application No. PCT/CN2015/075063, filed on Mar. 25, 2015.

(30) Foreign Application Priority Data
Mar. 31, 2014 (CN) 201410126999.4
Mar. 23, 2015 (CN) 201520165169.2

(51) Int. Cl. B01D 61/12; B01D 61/08; F16K 31/06; C02F 1/44; F16K 11/076; B01D 61/02; B01D 65/02

(52) U.S. Cl. CPC B01D 61/12; B01D 61/025; B01D 61/08; B01D 65/02; C02F 1/441; F16K 11/076; F16K 31/061; B01D 2313/18; B01D 2313/243; B01D 2313/24; B01D 2313/365; B01D 2313/50; B01D 2321/16; B01D 2321/205; C02F 2103/08

(57) ABSTRACT

A seawater desalination device including: a seawater introducing and filtering device, a seawater reverse osmosis filtering device, and a control circuit. The seawater reverse osmosis filtering device includes a first control valve and a second control valve. The seawater introducing and filtering device is connected to the first control valve of the seawater reverse osmosis filtering device. The second control valve is disposed at a terminal pipe of the seawater reverse osmosis filtering device. The control circuit is adapted to control operations of the seawater reverse osmosis filtering device.

### CROSS-REFERENCE TO RELATED APPLICATIONS

This application is a continuation-in-part of International Patent Application No. PCT/CN2015/075063 with an international filing date of Mar. 25, 2015, designating the United States, now pending, and further claims priority benefits to Chinese Patent Application No. 201410126999.4 filed Mar. 31, 2014, and to Chinese Patent Application No. 201520165169.2 filed Mar. 23, 2015. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

Field of the Invention

The invention relates to a seawater desalination device, a method for desalinating seawater using the same, and a method for cleaning the seawater desalination device.

Description of the Related Art

A typical seawater desalination method includes: precise filtration, pressurizing the seawater using a pressure pump, and preparation of the freshwater using a reverse osmosis membrane. However, when the pressure pump stops working, the seawater in the pressure pump and reverse osmosis membrane remains in and degrades the pressure pump and the reverse osmosis membrane. In addition, conventional cleaning methods of the reverse osmosis membrane are complex, which greatly slows down the maintenance of seawater desalination equipment.

### SUMMARY OF THE INVENTION

It is one objective of the invention to provide a seawater desalination device having two-way integrated control valves, a method for desalinating seawater using the same, and a method for cleaning the seawater desalination device. It is another objective to provide a seawater desalination device having two-position three-way solenoid valves, a method for desalinating seawater using the same, and a method for cleaning the seawater desalination device, in which, the two-way integrated control valves are substituted by the two-position three-way solenoid valves, and both the production cost and the fault rate of the system are reduced.

To achieve the above objective, in accordance with one embodiment of the invention, there is provided a seawater desalination device. The seawater desalination device comprises: a seawater introducing and filtering device, a seawater reverse osmosis filtering device, and a control circuit. The seawater reverse osmosis filtering device comprises a first control valve and a second control valve. The seawater introducing and filtering device is connected to the first control valve of the seawater reverse osmosis filtering device. The second control valve is disposed at a terminal pipe of the seawater reverse osmosis filtering device. The control circuit is adapted to control operation of the seawater reverse osmosis filtering device.

In a class of this embodiment, the seawater introducing and filtering device comprises: a seawater inlet valve, a seawater pump, and a precise filter assembly connected in that order via pipelines. The seawater reverse osmosis filtering device comprises: the first control valve, a pressure pump, a reverse osmosis membrane assembly, a pressure regulating valve, the second control valve, and a purge water tank connected in that order via pipelines. One end of the seawater inlet valve of the seawater introducing and filtering device is connected to a seawater inlet, and the other end of the seawater inlet valve is connected to the seawater pump. An outlet end of the seawater pump is connected to the precise filter assembly, and an outlet of the precise filter assembly is connected to the first control valve. The first control valve of the seawater introducing and filtering device is connected to the pressure pump, and the pressure pump is connected to a water inlet of the reverse osmosis membrane assembly. A freshwater outlet of the reverse osmosis membrane assembly is divided into two paths, one path is connected to a freshwater outlet valve, and the other path is connected to a purge water tank via a liquid level valve. The reverse osmosis membrane assembly further comprises a concentrated seawater outlet, and the concentrated seawater outlet is connected to the pressure regulating valve and second control valve. The purge water tank is connected to a water inlet of the pressure pump via the first control valve.

In a class of this embodiment, a first inlet of the first control valve communicates with an end of the seawater introducing and filtering device. A second inlet of the first control valve communicates with an output pipe of a purge water tank of the seawater reverse osmosis filtering device. An outlet of the first control valve communicates with an inlet of a pressure pump of the seawater reverse osmosis filtering device.

In a class of this embodiment, the first control valve comprises a first three-way solenoid valve. A first inlet of the first three-way solenoid valve communicates with the end of the seawater introducing and filtering device. A second inlet of the first three-way solenoid valve communicates with the output pipe of the purge water tank of the seawater reverse osmosis filtering device. An outlet of the first three-way solenoid valve communicates with the inlet of the pressure pump of the seawater reverse osmosis filtering device.

In a class of this embodiment, the seawater reverse osmosis filtering device further comprises a purge valve connected to the purge water tank. The first control valve is a first two-way integrated control valve comprising a water inlet valve and the purge valve. A first fluid channel is arranged in the water inlet valve, and a second fluid channel is arranged in the purge valve. The first fluid channel and the second fluid channel cooperate with a valve core rod of the first two-way integrated control valve by synchronous rotation. A contact is arranged on the valve core rod corresponding to a first contact switch and a second contact switch of different positions; the first contact switch and a switch of the pressure pump are in electric connection and form a first electrifying switch circuit. The second contact switch, a time controller, and the switch of the pressure pump are in electric connection and form a second electrifying switch circuit. When rotating the valve core rod to a first set position, the first fluid channel is in an open state while the second fluid channel is in a closed state, and the contact triggers the first contact switch to connect the first electrifying switch circuit; and when rotating the valve core rod to a second set position, the second fluid channel is in the open state while the first fluid channel is in the closed state, and the contact triggers the second contact switch to connect the second electrifying switch circuit.

In a class of this embodiment, an inlet of the second control valve communicates with a pressure regulating valve of the seawater reverse osmosis filtering device. A first outlet of the second control valve communicates with a concentrated water outlet of the seawater reverse osmosis filtering device. A second outlet of the second control valve communicates with an inlet of a purge water tank of the seawater reverse osmosis filtering device.

In a class of this embodiment, the second control valve comprises a second three-way solenoid valve; an inlet of the second three-way solenoid valve communicates with the pressure regulating valve of the seawater reverse osmosis filtering device. A first outlet of the second three-way solenoid valve communicates with the concentrated water outlet of the seawater reverse osmosis filtering device. A second outlet of the second three-way solenoid valve communicates with the inlet of the purge water tank of the seawater reverse osmosis filtering device.

In a class of this embodiment, the second control valve is a second two-way integrated control valve comprising a reflux valve and a water outlet valve. The reflux valve is arranged behind the pressure regulating valve in a water flow direction and communicates with the purge water tank. A third fluid channel is arranged in the water outlet valve, and a fourth fluid channel is arranged in the reflux valve. The third fluid channel and the fourth fluid channel cooperate with a valve core rod of the second two-way integrated control valve by synchronous rotation. A contact is arranged on the valve core rod corresponding to a third contact switch and a fourth contact switch of different positions; the third contact switch, a time controller, and a switch of the pressure pump are in electric connection and form a third electrifying switch circuit. The fourth contact switch, the time controller, and the switch of the pressure pump are in electric connection and form a fourth electrifying switch circuit. When rotating the valve core rod to a third set position, the third fluid channel is in an open state while the fourth fluid channel is in a closed state, and the contact triggers the third contact switch to connect the third electrifying switch circuit; and when rotating the valve core rod to a fourth set position, the fourth fluid channel is in the open state while the third fluid channel is in the closed state, and the contact triggers the fourth contact switch to connect the fourth electrifying switch circuit.

In a class of this embodiment, the first control valve and the second control valve are selected from one of the following combinations: 1) both the first control valve and the second control valve are electrically controlled three-way solenoid valves; 2) the first control valve is a manual two-position three-way valve, and the second valve is the electrically controlled three-way solenoid valve; 3) the first control valve is the electrically controlled three-way solenoid valve, and the second control valve is the manual two-position three-way valve; 4) both the first control valve and the second control valve are manual two-position three-way valves; 5) both the first control valve and the second control valve are pneumatically controlled two-position three-way valves; 6) the first control valve is the manual two-position three-way valve, and the second control valve is the pneumatically controlled two-position three-way valve; 7) the first control valve is the pneumatically controlled two-position three-way valve, and the second control valve is the manual two-position three-way valve; 8) the first control valve is the electrically controlled three-way solenoid valve, and the second control valve is the pneumatically controlled two-position three-way valve; 9) the first control valve is the pneumatically controlled two-position three-way valve, and the second control valve is the electrically controlled two-position three-way solenoid valve; 10) the first control valve is a manual type first two-way integrated control valve comprising the water inlet valve and the purge valve, and the second control valve is the electrically controlled three-way solenoid valve; 11) the first control valve is the electrically controlled three-way solenoid valve, and the second control valve is a manual type second two-way integrated control valve comprising the water outlet valve and the reflux valve communicating with the purge water tank; 12) the first control valve is the manual type first two-way integrated control valve comprising the water inlet valve and the purge valve, and the second control valve is the manual two-position three-way valve; 13) the first control valve is the manual two-position three-way valve, and the second control valve is the manual type second two-way integrated control valve comprising the water outlet valve and the reflux valve communicating with the purge water tank; 14) the first control valve is the manual type first two-way integrated control valve comprising the water inlet valve and the purge valve, and the second control valve is the pneumatically controlled two-position three-way valve; and 15) the first control valve is the pneumatically controlled two-position three-way valve, and the second control valve is the manual type second two-way integrated control valve comprising the water outlet valve and the reflux valve communicating with the purge water tank.

In a class of this embodiment, the control circuit comprises related circuits connected in parallel for controlling the first control valve, the second control valve, the pressure pump, and an off-delay controller or a programmable logic controller (PLC).

In a class of this embodiment, the control circuit is a switch circuit comprising the first electrifying switch circuit, the second electrifying switch circuit, the third electrifying switch circuit, and the fourth electrifying switch circuit connected in parallel.

In a class of this embodiment, the time controller is a time relay or a microcontroller unit (MCU).

In accordance with another embodiment of the invention, there is provided a seawater desalination device, comprising: a seawater introducing and filtering device, a control circuit, and a seawater reverse osmosis filtering device. The seawater introducing and filtering device comprises: a seawater inlet valve, a seawater pump, and a precise filter assembly connected in that order via pipelines. The seawater reverse osmosis filtering device comprises: a first control valve, a pressure pump, a reverse osmosis membrane assembly, a pressure regulating valve, a second control valve, and a purge water tank connected in that order via pipelines. The first control valve arranged between the seawater introducing and filtering device and the seawater reverse osmosis filtering device is a first three-way solenoid valve. A first inlet of the first three-way solenoid valve communicates with an end of the seawater introducing and filtering device. A second inlet of the first three-way solenoid valve communicates with an output pipe of the purge water tank of the seawater reverse osmosis filtering device; an outlet of the first three-way solenoid valve communicates with an inlet of a pressure pump of the seawater reverse osmosis filtering device. The control circuit is adapted to control operation of the seawater reverse osmosis filtering device.

In a class of this embodiment, the second control valve arranged on a pipe behind the pressure regulating valve of the seawater reverse osmosis filtering device in a water flow direction is a second three-way solenoid valve. An inlet of the second three-way solenoid valve communicates with the pressure regulating valve of the seawater reverse osmosis filtering device. A first outlet of the second three-way solenoid valve communicates with the concentrated water outlet of the seawater reverse osmosis filtering device. A second outlet of the second three-way solenoid valve communicates with an inlet of the purge water tank of the seawater reverse osmosis filtering device.

In accordance with still another embodiment of the invention, there is provided a seawater desalination device, comprising: a seawater introducing and filtering device, a seawater reverse osmosis filtering device, and a control circuit. The seawater introducing and filtering device comprises: a seawater inlet valve, a seawater pump, and a precise filter assembly connected in that order via pipelines. The seawater reverse osmosis filtering device comprises: a first control valve, a pressure pump, a reverse osmosis membrane assembly, a pressure regulating valve, a second control valve, and a purge water tank connected in that order via pipelines. The second control valve arranged on a pipe behind the pressure regulating valve of the seawater reverse osmosis filtering device in a water flow direction is a second three-way solenoid valve. An inlet of the second three-way solenoid valve communicates with the pressure regulating valve of the seawater reverse osmosis filtering device. A first outlet of the second three-way solenoid valve communicates with the concentrated water outlet of the seawater reverse osmosis filtering device. A second outlet of the second three-way solenoid valve communicates with an inlet of the purge water tank of the seawater reverse osmosis filtering device. The control circuit is adapted to control operation of the seawater reverse osmosis filtering device.

In a class of this embodiment, the seawater introducing and filtering device is connected to the first control valve of the seawater reverse osmosis filtering device. The first control valve is a first three-way solenoid valve. A first inlet of the first three-way solenoid valve communicates with an end of the seawater introducing and filtering device. A second inlet of the first three-way solenoid valve communicates with an output pipe of the purge water tank of the seawater reverse osmosis filtering device. An outlet of the first three-way solenoid valve communicates with an inlet of a pressure pump of the seawater reverse osmosis filtering device.

In accordance with still another embodiment of the invention, there is provided a method for desalinating seawater using the seawater desalination device. The first control valve of the seawater desalination device is a first two-way integrated control valve comprising a water inlet valve and a purge valve. A first fluid channel is arranged in the water inlet valve, and a second fluid channel is arranged in the purge valve. The first fluid channel and the second fluid channel cooperate with a valve core rod of the first two-way integrated control valve by synchronous rotation. A contact is arranged on the valve core rod corresponding to a first contact switch and a second contact switch of different positions. The first contact switch and a switch of a pressure pump are in electric connection and form a first electrifying switch circuit. The second contact switch, a time controller, and the switch of the pressure pump are in electric connection and form a second electrifying switch circuit. The method comprises the following steps:
1) rotating a valve core rod of the first two-way integrated control valve to a first set position to make the first fluid channel in an open state and the second fluid channel synchronously in a closed state, whereby allowing the contact to trigger the first contact switch to connect the first electrifying switch circuit;
2) continuously pumping the seawater by the pressure pump to the reverse osmosis membrane assembly for preparing freshwater, discharging the prepared freshwater from a freshwater outlet of the reverse osmosis membrane assembly in two paths, and allowing one path of the freshwater to pass through a freshwater outlet valve and then discharging the path of the freshwater for use, and allowing the other path of the freshwater to pass through a liquid level valve and reach a purge water tank; and allowing a concentrated seawater produced from filtration to pass through a pressure regulating valve and discharging the concentrated seawater via a water outlet valve;
3) when the seawater desalination is finished and the seawater desalination device is to be stopped, rotating the valve core rod of the first two-way integrated control valve to a second set position to make the second fluid channel in the open state and the first fluid channel in the closed state, whereby allowing the contact to trigger the second contact switch to connect the second electrifying switch circuit; and
4) controlling a pressure pump to operate for a set time by a time controller of the second electrifying switch circuit, whereby introducing the freshwater of the purge water tank via the purge valve to the pressure pump, pumping the freshwater to the reverse osmosis membrane assembly from the pressure pump for replacing the seawater in the reverse osmosis membrane assembly, and discharging replaced seawater via the pressure regulating valve and the water outlet valve.

In accordance with still another embodiment of the invention, there is provided a method for cleaning the seawater desalination device. The first control valve of the seawater desalination device is a first two-way integrated control valve comprising a water inlet valve and a purge valve. A first fluid channel is arranged in the water inlet valve, and a second fluid channel is arranged in the purge valve; the first fluid channel and the second fluid channel cooperate with a valve core rod of the first two-way integrated control valve by synchronous rotation. The second control valve is a second two-way integrated control valve comprising a reflux valve and a water outlet valve; the reflux valve is arranged behind the pressure regulating valve in a water flow direction and communicates with a purge water tank. A third fluid channel is arranged in the water outlet valve, and a fourth fluid channel is arranged in the reflux valve. The third fluid channel and the fourth fluid channel cooperate with a valve core rod of the second two-way integrated control valve by synchronous rotation. The method comprises:
1) when the reverse osmosis membrane assembly requires cleaning, adding a detergent to a purge water tank, disconnecting a first three-way solenoid valve, rotating a valve core rod of a first two-way integrated control valve to a second set position to make a second fluid channel in an open state and a first fluid channel in a closed state; in the meanwhile, rotating a valve core rod of a second two-way integrated control valve to a fourth set position to make the fourth fluid channel in the open state and the third fluid channel in the closed state and to trigger a fourth contact switch to connect a fourth electrifying switch circuit by a contact;
2) controlling the pressure pump to operate for a set time by a time controller of the fourth electrifying switch circuit, during which, introducing the detergent of the purge water tank to the pressure pump via a purge valve, pumping the detergent by the pressure pump to the reverse osmosis membrane assembly for cleaning the reverse osmosis membrane assembly, and refluxing the detergent from the reverse osmosis membrane assembly to the purge tank, thus realizing repeated cycles of cleaning of the reverse osmosis membrane assembly;
3) when the set time of the time controller in the fourth electrifying switch circuit is reached, rotating the valve core rod of the second two-way integrated control valve to a third set position to make the third fluid channel in the open state and the fourth fluid channel in the closed state and to trigger a third contact switch to connect a third electrifying switch circuit by a contact; and
4) controlling the pressure pump to operate for a set time by the time controller of the third electrifying switch circuit, during which, introducing the detergent of the purge water tank to the pressure pump via a purge valve, pumping the detergent by the pressure pump to the reverse osmosis membrane assembly, and discharging the detergent via the pressure regulating valve and a water outlet valve.

In accordance with still another embodiment of the invention, there is provided a method for desalinating seawater using the seawater desalination device. The first control valve is a first three-way solenoid valve, and the second control valve is a second three-way solenoid valve. The method comprises the following steps:
1) when desalinating the seawater, starting a first three-way solenoid valve to make a first inlet channel in an open state and a second inlet channel synchronously in a closed state, whereby allowing the seawater to pass through the first inlet channel to a pressure pump; in the meanwhile, making the second three-way solenoid valve in a halt state, and making a first outlet channel of the second three-way solenoid valve in an open state and a second outlet channel thereof in a closed state;
2) starting the pressure pump, continuously pumping the seawater by the pressure pump to a reverse osmosis membrane assembly to prepare freshwater; discharging the prepared freshwater from a freshwater outlet of the reverse osmosis membrane assembly in two paths, and allowing one path of the freshwater to pass through a freshwater outlet valve and then discharging the path of the freshwater for use, and allowing the other path of the freshwater to pass through a liquid level valve and reach a purge water tank; and allowing a concentrated seawater produced from filtration to pass through a pressure regulating valve and discharging the concentrated seawater via the first outlet channel of the second three-way solenoid valve and a concentrated water outlet;
3) when the seawater desalination is finished and the seawater desalination device is to be stopped, disconnecting the first three-way solenoid valve and at the same time allowing a time controller to operate, and allowing the second inlet channel to be in the open state and the first inlet channel to be in the closed state, and introducing the freshwater in the purge water tank via the second inlet channel to the pressure pump; and operating the pressure pump for a set time under the control of the time controller; and
4) pumping the freshwater from the purge water tank to the reverse osmosis membrane assembly by the pressure pump, replacing the seawater in the reverse osmosis membrane assembly, and discharging replaced seawater via the pressure regulating valve, the first outlet channel of the second three-way solenoid valve, and the concentrated water outlet.

In accordance with still another embodiment of the invention, there is provided a method for cleaning the seawater desalination device. The first control valve is a first three-way solenoid valve, and the second control valve is a second three-way solenoid valve. The method comprises:
1) when the reverse osmosis membrane assembly requires cleaning, adding a detergent to a purge water tank, disconnecting a first three-way solenoid valve, opening a second inlet channel and allowing the detergent of the purge water tank to flows to a pressure pump, and closing a first inlet channel for preventing the seawater from inside; in the meanwhile, connecting a second three-way solenoid valve and starting the pressure pump and a time controller, opening a second outlet channel of the second three-way solenoid valve and closing a first outlet channel for preventing the detergent from discharging;
2) pumping the detergent of the purge water tank to the reverse osmosis membrane assembly by the pressure pump, allowing the detergent to pass through a pressure regulating valve and the second outlet channel of the second three-way solenoid valve to enter the purge water tank and the second inlet channel of the first three-way solenoid valve respectively to return to the pressure pump, thus realizing repeated cycles of cleaning of the reverse osmosis membrane assembly; and
3) disconnecting the second three-way solenoid valve at a set time by the time controller, closing the second outlet of the second three-way solenoid valve, stopping the cycles of cleaning, and discharging the detergent from a concentrated water outlet via the first outlet channel of the second three-way solenoid valve; and stopping operation of the pressure pump at a set time by the time controller.

Advantages of the seawater desalination device, the method for desalinating seawater using the same, and the method for cleaning the seawater desalination device according to embodiments of the invention are summarized as follows:
1) By adopting the above structures, the first two-way integrated control valve of the seawater desalination device is able to synchronously control the on/off state of both the water inlet valve and the purge valve. It only requires the action of rotating the valve core rod to make the water inlet valve and the purge valve switched between the normal seawater desalination and the freshwater replacement in a halt state, and the contact switch and the time controller are employed to control the operation state of the pressure pump. In addition, the second two-way integrated control valve is used at the same time to control the on/off state of the water outlet valve and the reflux valve. It only requires the action of rotating the valve core rod to make the water outlet valve and the reflux valve switched between the cleaning using the detergent and the discharging of the detergent, and the contact switch and the time controller are employed to control the operation state of the pressure pump.
2) The seawater desalination structure is improved to realize the seawater desalination operation, the cleaning operation in the halt state, and the cleaning by the detergent by only one action, i. e., regulating the two-way integrated control valve, so that the process is greatly simplified, the operation steps are saved, and the working efficiency is improved. The pressure pump of the invention generally adopts a plunger type pressure pump.
3) Two two-way integrated control valves are employed and both the valves are based on the same principle. Specific structures can be the same or respectively adopts the series connected structure in FIG. 6 or the parallel connected structure in FIG. 7. The two valves are respectively arranged at water inlet position and water outlet position, thus saving the operation steps of the cleaning operation in the halt state, and the cleaning by the detergent, simplifying the structure, and improving the efficiency.
4) Working processes of the seawater desalination, the cleaning in the halt state, and the cleaning by the detergent can be realized by only one action, i. e., regulating the first three-way solenoid valve and the second three-way solenoid valve, so that the processes are greatly simplified, the operation steps are saved, and the working efficiency is improved.
5) The original two control valves are substituted by one solenoid valve, thus simplifying the structure, reducing the production cost of the system, decreasing the fault rate of the system, being convenient in maintenance and automatically controllable.
6) The structure of the system is optimized, and multiple contact switches of the original product are saved, so that the efficiency of the freshwater preparation is significantly improved.
7) Multiple combinations of control valves including the electrically controlled, manually controlled, and pneumatically controlled valves are provided to meet different demands of users.

### BRIEF DESCRIPTION OF THE DRAWINGS

The invention is described hereinbelow with reference to the accompanying drawings, in which:

FIG. 1 is a structure diagram showing connection of a seawater reverse osmosis filtering device in accordance with one embodiment of the invention;

FIG. 2 is a structure diagram of a seawater introducing and filtering device in accordance with one embodiment of the invention;

FIG. 3 is a schematic diagram of a two-way integrated control valve in accordance with one embodiment of the invention;

FIG. 4 shows a first working state of a valve core rod with a cross sectional view of part IV-IV in FIG. 3;

FIG. 5 shows a second working state of a valve core rod with a cross sectional view of part IV-IV in FIG. 3;

FIG. 6 is a stereogram of a two-way integrated control valve in series connection in accordance with one embodiment of the invention;

FIG. 7 is a stereogram of a two-way integrated control valve in parallel connection in accordance with one embodiment of the invention;

FIG. 8 is a systematic structure diagram of a seawater desalination device in accordance with one embodiment of the invention, in which both a first control valve and a second control valve are electrically controlled three-way solenoid valve;

FIG. 9 is a systematic structure diagram of a seawater desalination device in accordance with one embodiment of the invention, in which a first control valve is an electrically controlled three-way solenoid valve, and a second control valve is a second two-way integrated control valve; and

FIG. 10 is a systematic structure diagram of a seawater desalination device in accordance with one embodiment of the invention, in which a first control valve is a first two-way integrated control valve, and a second control valve is an electrically controlled three-way solenoid valve.

### DETAILED DESCRIPTION OF THE EMBODIMENTS

For further illustrating the invention, experiments detailing a seawater desalination device, a method for desalinating seawater using the same, and a method for cleaning the seawater desalination device are described below. It should be noted that the following examples are intended to describe and not to limit the invention.

### EXAMPLE 1

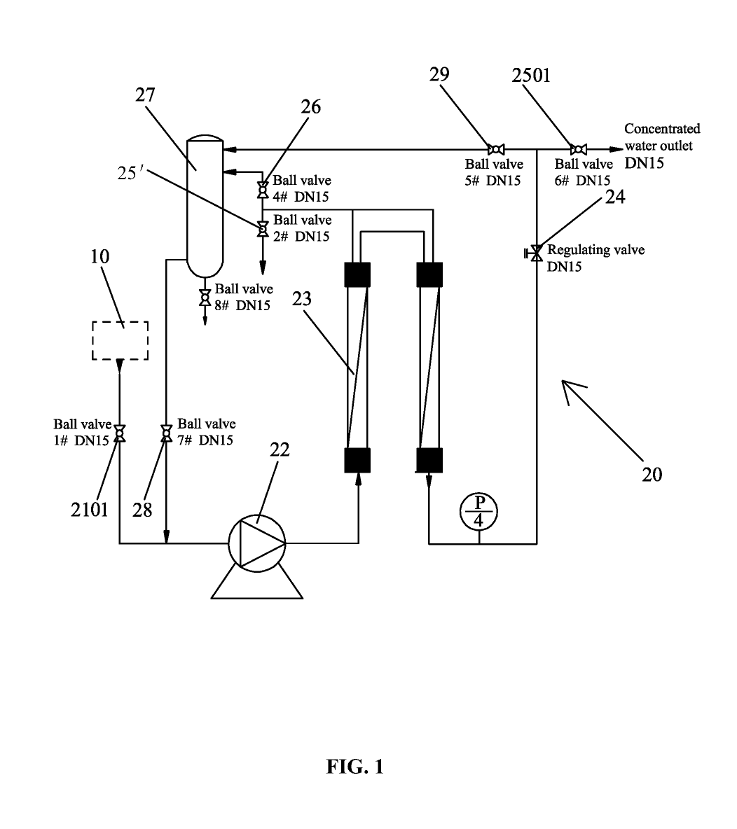

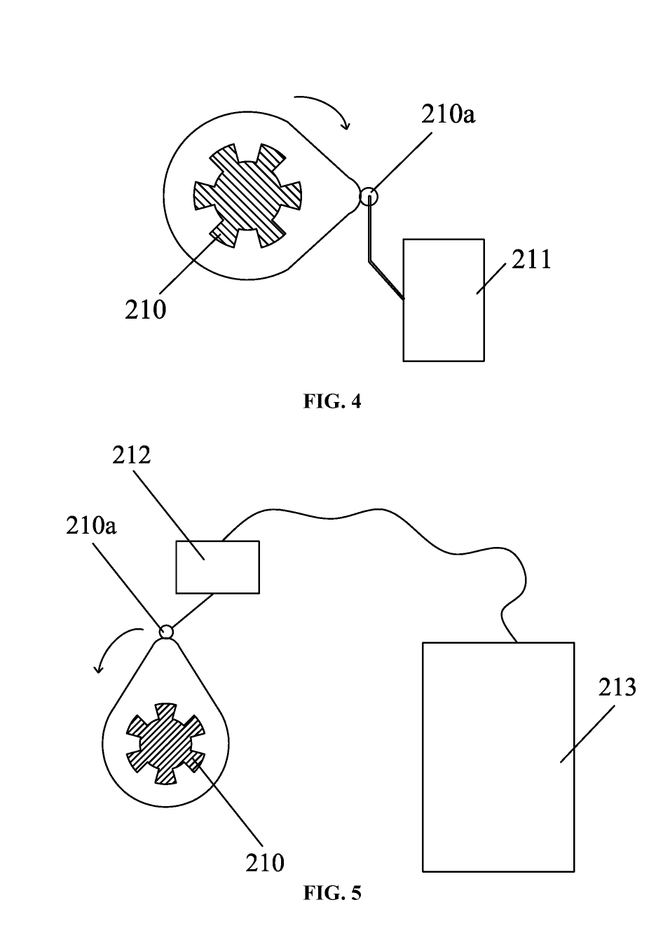

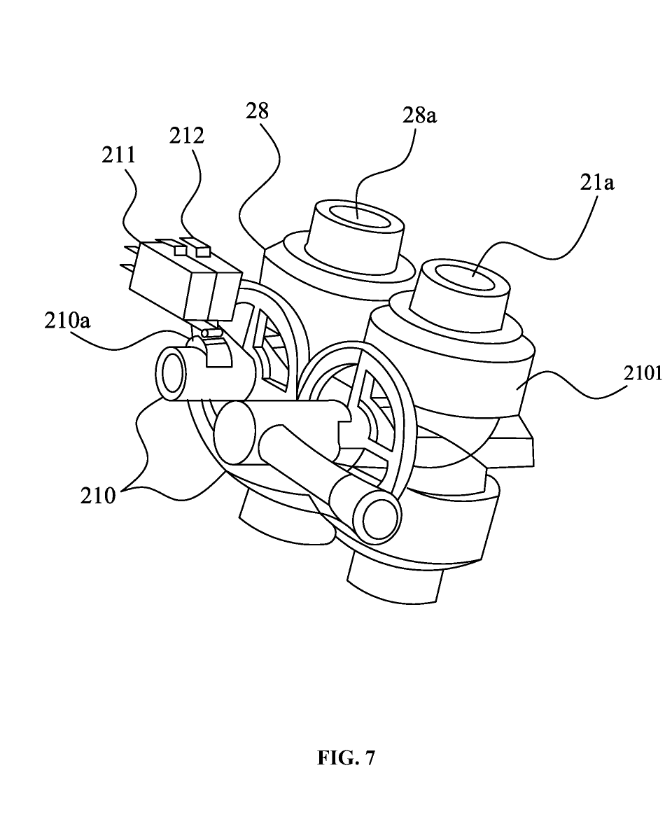

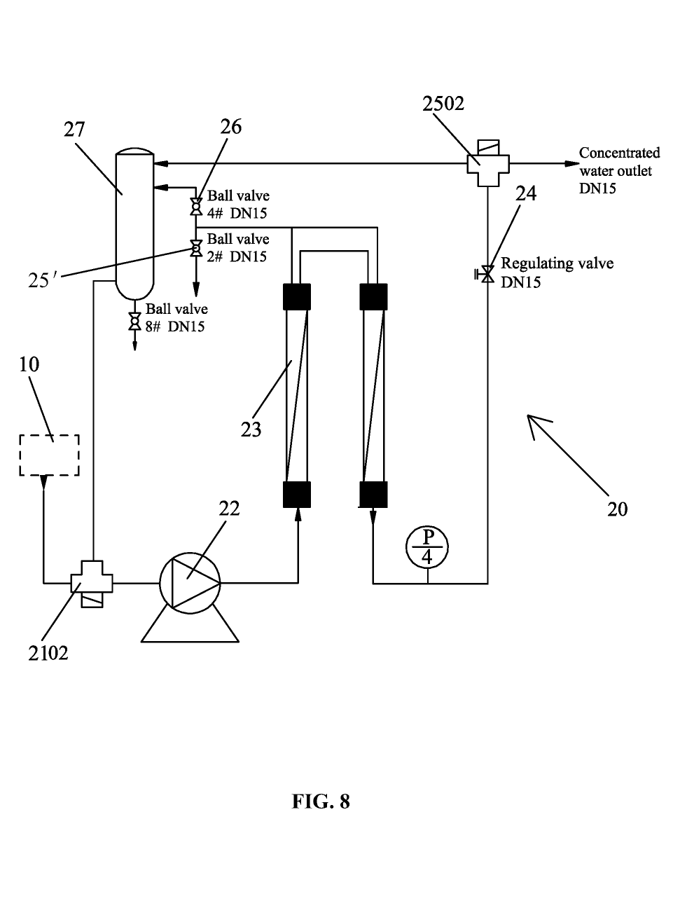

As shown in FIGS. 1-7, a seawater desalination device comprises a seawater introducing and filtering device 10 and a seawater reverse osmosis filtering device 20. The seawater reverse osmosis filtering device 20 comprises a water inlet valve 2101, a pressure pump 22, a reverse osmosis membrane assembly 23, a pressure regulating valve 24, a water outlet valve 2501, a freshwater outlet valve 25′, a liquid level valve 26, a purge water tank 27, and a purge valve 28.

The seawater is filtrated in the seawater introducing and filtering device 10; following the filtration, the seawater passes through the water inlet valve 2101 and is communicated with the pressure pump 22. Then the seawater is communicated with a water inlet of the reverse osmosis membrane assembly 23 to produce fresh water. The freshwater is distributed to two paths from a freshwater outlet of the reverse osmosis membrane assembly 23. One path is communicated with the freshwater outlet valve 25′ and is discharged from the freshwater outlet valve; and the other path is communicated with the liquid level valve 26 and is allowed to enter the purge water tank 27. The concentrated seawater produced during the filtration passes through the pressure regulating valve 24 and is discharged from the water outlet valve 2501. The purge water tank 27 is connected to a water inlet of the pressure pump 22 via the purge valve 28.

The water inlet valve 2101 and the purge valve 28 are integrated to from a first two-way integrated control valve which is ganged. The water inlet valve 2101 comprises a first fluid channel 21a, and the purge valve 28 comprises a second fluid channel 28a. The first fluid channel 21a and the second fluid channel 28a are coordinated with and simultaneously rotated with a valve core rod 210. The valve core rod 210 comprises a contact 210a, and the contact 210a is corresponding to a first contact switch 211 and a second contact switch 212 which are disposed at different positions, respectively. The first contact switch 211 is electrically connected to a switch of the pressure pump 22 to form a first electrifying switch circuit, and the second contact switch 212 is electrically connected to a time controller 213 and a switch of the pressure pump 22 to form a second electrifying switch circuit.

When the valve core rod 210 is rotated to a first set position, the first fluid channel 21a is in an on state, and the second fluid channel 28a is in an off state. The contact triggers the first contact switch 211, and the first electrifying switch circuit is turned on.

When the valve core rod 210 is rotated to a second set position, the second fluid channel 28a is in an on state, and the first fluid channel 21a is in an off state. The contact triggers the second contact switch 212, and the second electrifying switch circuit is turned on.

The contact switch is described above is only one embodiment of the invention. Optionally, the contact switch is substituted by other switches of similar functions, such as a proximity switch or a Hall switch.

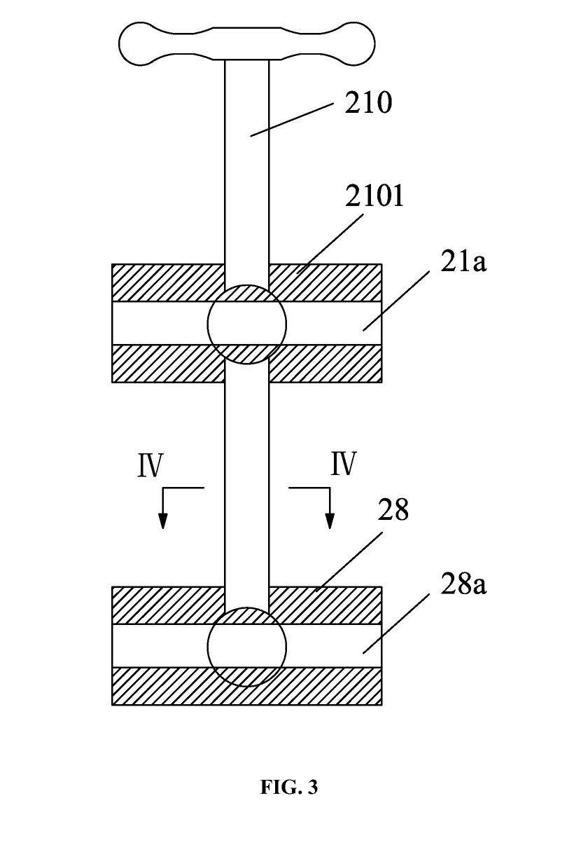

In addition to the pressure regulating valve 24, a reflux valve 29 is also provided in the invention. The reflux valve 29 is communicated with the purge water tank 27. The reflux valve 29 and the water outlet valve 2501 are integrated to form a second two-way integrated control valve which is ganged. The second two-way integrated control valve follows a basic structure and principle of the first two-way integrated control valve. As shown in FIGS. 3-7, the water outlet valve 2501 comprises a third fluid channel, and the reflux valve 29 comprises a fourth fluid channel. The third fluid channel and the fourth fluid channel are coordinated with and simultaneously rotated with a valve core rod. The valve core rod comprises a contact, and the contact is corresponding to a third contact switch and a fourth contact switch which are disposed at different positions, respectively. The third contact switch is electrically connected to a time controller 213 and a switch of the pressure pump to form a third electrifying switch circuit, and the fourth contact switch is electrically connected to a time controller and a switch of the pressure pump to form a fourth electrifying switch circuit.

When the valve core rod is rotated to a third set position, the third fluid channel is in an on state, and the fourth fluid channel is in an off state. The contact triggers the third contact switch, and the third electrifying switch circuit is turned on.

When the valve core rod is rotated to a fourth set position, the fourth fluid channel is in an on state, and the third fluid channel is in an off state. The contact triggers the fourth contact switch, and the fourth electrifying switch circuit is turned on.

The seawater introducing and filtering device comprises a seawater inlet valve 11, a seawater pump 12, and a precision precise filter assembly 13. An end of the seawater inlet valve 11 is connected to a seawater inlet, and another end of the seawater inlet valve 11 is connected to the seawater pump 12. An outlet end of the seawater pump 12 is connected to the precision precise filter assembly 13. An outlet of the precision precise filter assembly 13 is connected to the water inlet valve 2101.

The time controller 213 is a time relay or a MCU.

The first electrifying switch circuit, the second electrifying switch circuit, the third electrifying switch circuit, and the fourth electrifying switch circuit are parallel switch circuits.

A seawater desalination method of the seawater desalination device in operation and during downtime in the invention, the method comprising:

1) when the seawater needs to be desalinated, the valve core rod 210 of the first two-way integrated control valve is rotated to a first set position, thus the first fluid channel 21a is in an on state, and simultaneously the second fluid channel 28a is in an off state; the contact triggers the first contact switch 211, and the first electrifying switch circuit is turned on;

2) the pressure pump 22 is allowed to constantly pump the seawater to the reverse osmosis membrane assembly 23 to produce fresh water; the freshwater is distributed to two paths from a freshwater outlet of the reverse osmosis membrane assembly 23; one path is communicated with the freshwater outlet valve 25′ and is discharged from the freshwater outlet valve; and the other path is communicated with the liquid level valve 26 and is allowed to enter the purge water tank 27; the concentrated seawater produced during the filtration passes through the pressure regulating valve 24 and is discharged from the water outlet valve 2501;

3) when the seawater desalination device is turned off as the desalination is finished, the valve core rod 210 of the first two-way integrated control valve is rotated to a second set position, thus the second fluid channel 28a is in an on state, and the first fluid channel 21a is in an off state; the contact triggers the second contact switch 212, and the second electrifying switch circuit is turned on;

4) the pressure pump 22 is controlled by the time controller 213 of the second electrifying switch circuit, and the time controller sets time to turn off the pressure pump; during an operation of the pressure pump 22, the freshwater in the purge water tank 27 is allowed to enter the pressure pump 22 via the purge valve 28, and then the freshwater is pumped to the reverse osmosis membrane assembly 23 from the pressure pump 22 to replace the seawater in the reverse osmosis membrane assembly 23; and the replaced seawater passes through the pressure regulating valve 24 and is discharged from the water outlet valve 2501;

A method for cleaning the reverse osmosis membrane assembly of the seawater desalination device after long-term service using detergent, the method comprising:

1) when the reverse osmosis membrane assembly needs to be cleaned by detergent, the detergent is added to the purge water tank 27; the valve core rod 210 of the first two-way integrated control valve is rotated to a second set position, thus the second fluid channel 28a is in an on state, and the first fluid channel 21a is in an off state; meanwhile, the valve core rod of the second two-way integrated control valve is rotated to a fourth set position, the fourth fluid channel is in an on state, and the third fluid channel is in an off state; the contact triggers the fourth contact switch, and the fourth electrifying switch circuit is turned on;

2) the pressure pump is controlled by the time controller of the fourth electrifying switch circuit, and the time controller sets time to turn off the pressure pump; during an operation of the pressure pump, the detergent in the purge water tank 27 is allowed to enter the pressure pump 22 via the purge valve 28, and then the detergent is pumped to the reverse osmosis membrane assembly 23 from the pressure pump 22 to clean the reverse osmosis membrane assembly 23; then the detergent passes through the fourth fluid channel of the reflux valve 29 and is allowed to return back to the purge water tank 27; the above process is repeated to clean the reverse osmosis membrane assembly;

3) when the set time of the time controller of the fourth electrifying switch circuit is over, the valve core rod of the second two-way integrated control valve is rotated to a third set position, thus the third fluid channel is in an on state, and the fourth fluid channel is in an off state; the contact triggers the third contact switch, and the third electrifying switch circuit is turned on;

4) the pressure pump 22 is then controlled by the time controller of the third electrifying switch circuit, and the time controller sets time to turn off the pressure pump; during an operation of the pressure pump 22, the detergent in the purge water tank 27 is allowed to enter the pressure pump 22 via the purge valve 28, and then the detergent is pumped to the reverse osmosis membrane assembly 23 from the pressure pump 22; the detergent passes through the reverse osmosis membrane assembly 23 and the pressure regulating valve 24, and is discharged from the water outlet valve.

### EXAMPLE 2

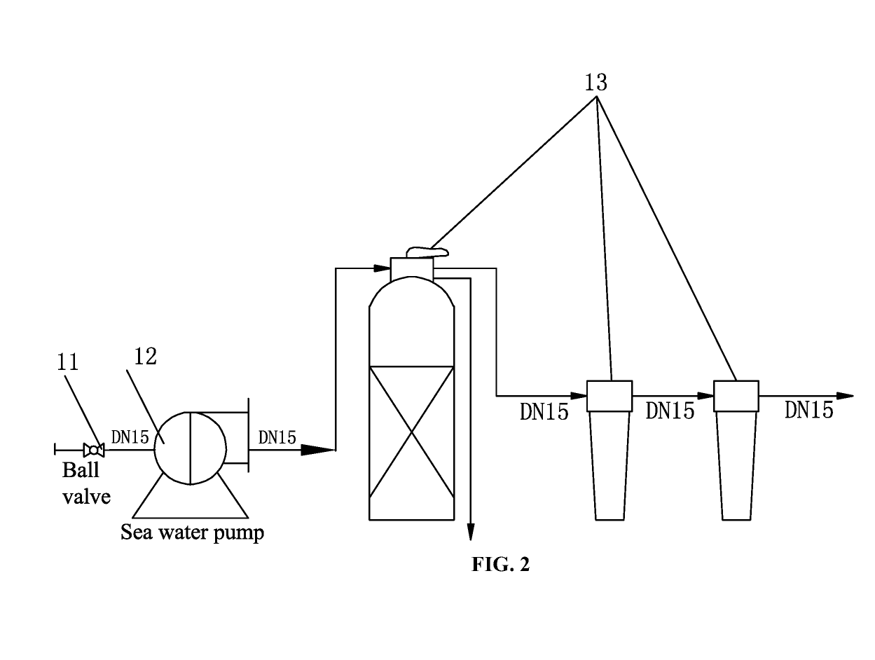

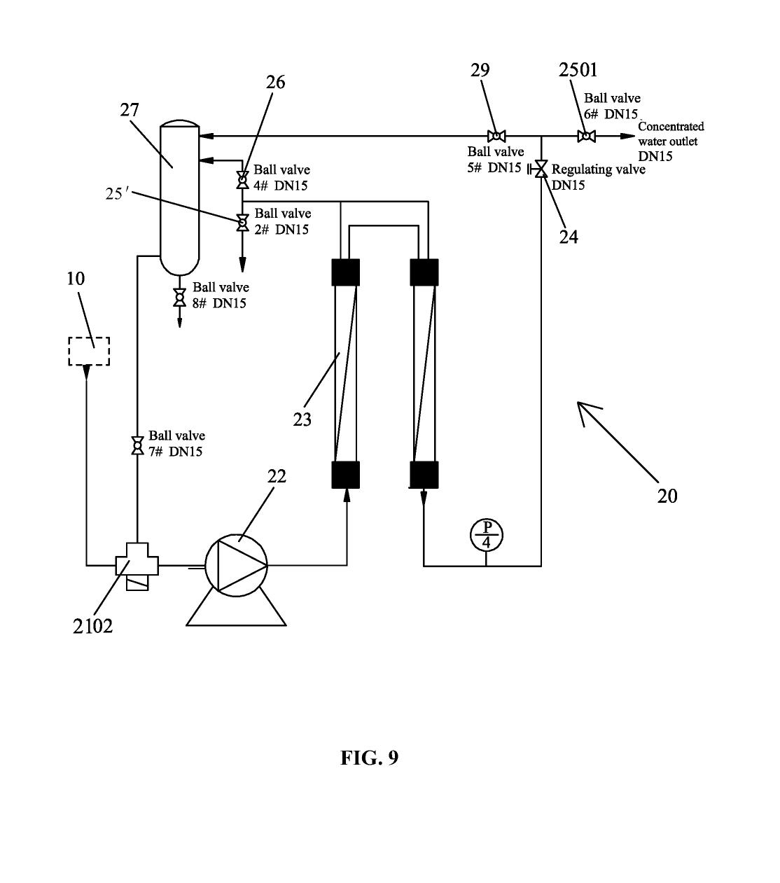

As shown in FIGS. 2 and 8, a seawater desalination device comprises a seawater introducing and filtering device 10 and a seawater reverse osmosis filtering device 20.

As shown in FIG. 2, the seawater introducing and filtering device comprises a seawater inlet valve 11, a seawater pump 12, and a precise filter assembly 13. An end of the seawater inlet valve 11 is connected to a seawater inlet, and another end of the seawater inlet valve 11 is connected to the seawater pump 12. An outlet end of the seawater pump 12 is connected to the precise filter assembly 13. An outlet of the precise filter assembly 13 is connected to a first three-way solenoid valve 2102.

As shown in FIG. 8, the first three-way solenoid valve 2102 is disposed between the seawater introducing and filtering device 10 and the seawater reverse osmosis filtering device 20. A first inlet of the first three-way solenoid valve 2102 is connected to an end of the seawater introducing and filtering device 10. The second inlet of the first three-way solenoid valve 2102 is communicated with an output line of the purge water tank 27 in the seawater reverse osmosis filtering device 20. A first outlet of the first three-way solenoid valve 2102 is connected to an inlet of the pressure pump 22 in the seawater reverse osmosis filtering device 20. The seawater is filtrated in the seawater introducing and filtering device 10; following the filtration, the seawater passes through the first three-way solenoid valve 2102 and is communicated with the pressure pump 22. Then the seawater is communicated with a water inlet of the reverse osmosis membrane assembly 23 to produce fresh water. The freshwater is distributed to two paths from a freshwater outlet of the reverse osmosis membrane assembly 23. One path is communicated with the freshwater outlet valve 25′ and is discharged from the freshwater outlet valve; and the other path is communicated with the liquid level valve 26 and is allowed to enter the purge water tank 27. The concentrated seawater produced during the filtration passes through the pressure regulating valve 24 and is discharged from a second three-way solenoid valve 2502. A first inlet of the second three-way solenoid valve 2502 is communicated with the pressure regulating valve 24. A first outlet of the second three-way solenoid valve 2502 is communicated with a concentrated seawater outlet in the seawater reverse osmosis filtering device 20. A second outlet of the second three-way solenoid valve 2502 is connected to the inlet of the purge water tank 27 in the seawater reverse osmosis filtering device 20. The seawater desalination device further comprises a control circuit. The control circuit comprises the first three-way solenoid valve 2102, the second three-way solenoid valve 2502, the pressure pump 22, and an off-delay controller or a PLC. The first three-way solenoid valve 2102, the second three-way solenoid valve 2502, the pressure pump 22, and an off-delay controller (not shown) or a PLC (not shown) are parallel.

As shown in FIG. 8, a seawater desalination method of the seawater desalination device in operation and during downtime in the invention, the method comprising:

1) when the seawater needs to be desalinated, the first three-way solenoid valve 2102 is turned on, thus a first inlet channel is in an on state, and simultaneously the second inlet channel is in an off state; the seawater is allowed to flow in the pressure pump 22 via the first inlet channel; at the same time, the second three-way solenoid valve 2502 is turned off, thus a first outlet channel of the second three-way solenoid valve 2502 is in an on state, and a second outlet channel is in an off state;

2) the pressure pump 22 is allowed to constantly pump the seawater to the reverse osmosis membrane assembly 23 to produce fresh water; the freshwater is distributed to two paths from a freshwater outlet of the reverse osmosis membrane assembly 23; one path is communicated with the freshwater outlet valve 25′ and is discharged from the freshwater outlet valve; and the other path is communicated with the liquid level valve 26 and is allowed to enter the purge water tank 27; the concentrated seawater produced during the filtration passes through the pressure regulating valve 24 and the first outlet channel of the second three-way solenoid valve 2502, and is discharged from the concentrated seawater outlet;

3) when the seawater desalination device is turned off as the desalination is finished, the first three-way solenoid valve 2102 is turned off, meanwhile the time controller 213 is actuated, thus the second inlet channel is in an on state, and the first inlet channel is in an off state; the freshwater in the purge water tank 27 is allowed to flow to the pressure pump 22 via the second inlet channel; the pressure pump 22 is controlled by the time controller 213, and the time controller sets time to turn off the pressure pump;

4) the freshwater in the purge water tank 27 is pumped to the reverse osmosis membrane assembly 23 via the pressure pump 22 to replace the seawater in the reverse osmosis membrane assembly 23; and the replaced seawater passes through the pressure regulating valve 24 and the first outlet channel of the second three-way solenoid valve 2502, and is discharged from the concentrated seawater outlet.

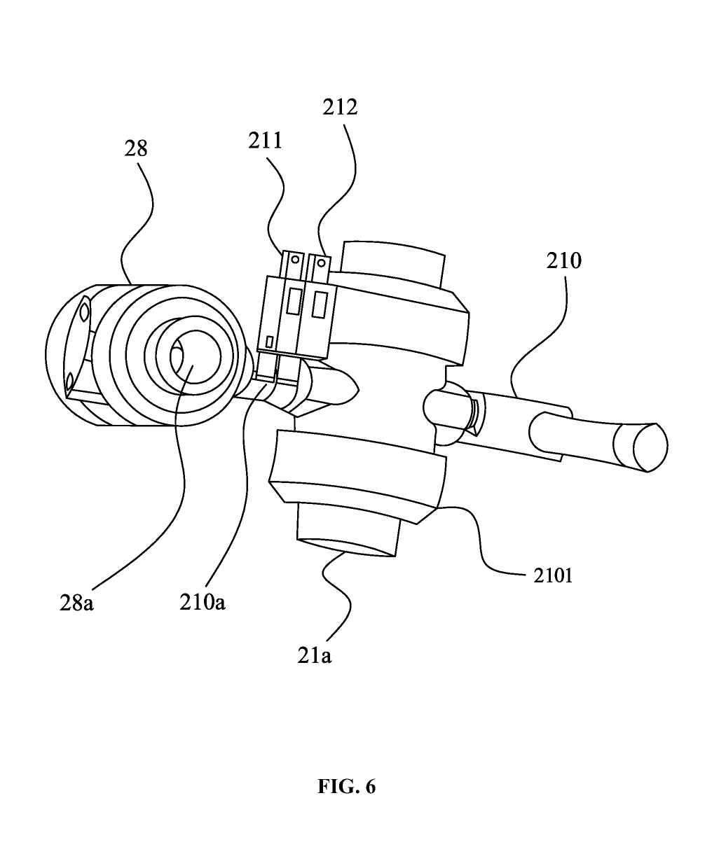

As shown in FIGS. 2 and 5, a method for cleaning the reverse osmosis membrane assembly 23 of the seawater desalination device after long-term service using detergent, the method comprising:

1) when the reverse osmosis membrane assembly 23 needs to be cleaned by detergent, the detergent is added to the purge water tank 27; the first three-way solenoid valve 2102 is turned off, thus the second inlet channel is in an on state, the detergent in the purge water tank 27 is allowed to flow in the pressure pump 22; the first inlet channel is in an off state, thus preventing the seawater from entering in; meanwhile, the second three-way solenoid valve 2502 is turned on, and the pressure pump 22 and the time controller 213 are actuated, thus the second outlet channel of the second three-way solenoid valve 2502 is in an on state, and the first outlet channel is in an off state, preventing the detergent from being discharged;

2) the detergent in the purge water tank 27 is pumped to the reverse osmosis membrane assembly 23 via the pressure pump 22; then the detergent passes through the pressure regulating valve 24 and the second outlet channel of the second three-way solenoid valve 2502, and is allowed to return back to the purge water tank 27; the detergent then is allowed to enter the pressure pump 22 via the second inlet channel of the first three-way solenoid valve 2102 to repeat the cleaning of the reverse osmosis membrane assembly 23;

3) the time controller 213 operates to control the second three-way solenoid valve 2502, and the time controller sets time to turn off the second three-way solenoid valve; the second outlet channel of the second three-way solenoid valve 2502 is in an off state, thus the cyclic cleaning is stopped; the detergent passes through the first outlet channel of the second three-way solenoid valve 2502 and is discharged from the concentrated seawater outlet; again the time controller 213 operates to control the pressure pump, and sets time to turn off the pressure pump.

In the example, the first three-way solenoid valve 2102 and the second three-way solenoid valve 2502 are electrically controlled; except the example, the following alternative combinations is optional according to needs for those skilled in the art:

1) the first control valve is a manual two-position three-way valve, and the second control valve is an electrically controlled three-way solenoid valve;

2) the first control valve is an electrically controlled three-way solenoid valve, and the second control valve is a manual two-position three-way valve;

3) the first control valve and the second control valve are manual two-position three-way valve;

4) the first control valve is a manual two-position three-way valve, and the second control valve is an electrically controlled two-position three-way gas control valve;

5) the first control valve is an electrically controlled two-position three-way gas control valve, and the second control valve is a manual two-position three-way valve;

6) the first control valve is an electrically controlled two-position three-way gas control valve, and the second control valve is an electrically controlled two-position three-way solenoid valve;

7) the first control valve is a manual integrated control valve which is ganged and integrates a water inlet valve and a purge valve, and the second control valve is a manual two-position three-way valve;

8) the first control valve is a manual two-position three-way valve, and the second control valve is a manual integrated control valve which is ganged and integrates a water inlet valve and a purge valve;

9) the first control valve is a manual integrated control valve which is ganged and integrates a water inlet valve and a purge valve, and the second control valve is an electrically controlled two-position three-way gas control valve; and

10) the first control valve is an electrically controlled two-position three-way gas control valve, and the second control valve is a manual integrated control valve which is ganged and integrates a water inlet valve and a purge valve.

### EXAMPLE 3

As shown in FIGS. 2, 3, 4, 5, and 9, a seawater desalination device comprises a seawater introducing and filtering device 10 and a seawater reverse osmosis filtering device 20.

As shown in FIG. 2, the seawater introducing and filtering device comprises a seawater inlet valve 11, a seawater pump 12, and a precise filter assembly 13. An end of the seawater inlet valve 11 is connected to a seawater inlet, and another end of the seawater inlet valve 11 is connected to the seawater pump 12. An outlet end of the seawater pump 12 is connected to the precise filter assembly 13. An outlet of the precise filter assembly 13 is connected to a first three-way solenoid valve 2102.

As shown in FIG. 9, the first three-way solenoid valve 2102 is disposed between the seawater introducing and filtering device 10 and the seawater reverse osmosis filtering device 20. The seawater is filtrated in the seawater introducing and filtering device 10; following the filtration, the seawater passes through the first three-way solenoid valve 2102 and is communicated with the pressure pump 22. A first inlet of the first three-way solenoid valve 2102 is connected to an end of the seawater introducing and filtering device 10. The second inlet of the first three-way solenoid valve 2102 is communicated with an output line of the purge water tank 27 in the seawater reverse osmosis filtering device 20. A first outlet of the first three-way solenoid valve 2102 is connected to an inlet of the pressure pump 22 in the seawater reverse osmosis filtering device 20. Then the seawater is communicated with a water inlet of the reverse osmosis membrane assembly 23 to produce fresh water. The freshwater is distributed to two paths from a freshwater outlet of the reverse osmosis membrane assembly 23. One path is communicated with the freshwater outlet valve 25′ and is discharged from the freshwater outlet valve; and the other path is communicated with the liquid level valve 26 and is allowed to enter the purge water tank 27.

As shown in FIGS. 1, 3, and 4, the concentrated seawater produced during the filtration passes through the pressure regulating valve 24 and is discharged from the water outlet valve 2501. In addition to the pressure regulating valve 24, a reflux valve 29 is also provided in the invention. The reflux valve 29 is communicated with the purge water tank 27. The reflux valve 29 and the water outlet valve 2501 are integrated to form a second two-way integrated control valve which is ganged. The water outlet valve 2501 comprises a third fluid channel, and the reflux valve 29 comprises a fourth fluid channel. The third fluid channel and the fourth fluid channel are coordinated with and simultaneously rotated with a valve core rod 210. The valve core rod 210 comprises a contact 210a, and the contact 210a is corresponding to a third contact switch (not shown) and a fourth contact switch (not shown) which are disposed at different positions, respectively. The third contact switch (not shown) is electrically connected to a PLC and a switch of the pressure pump to form a third electrifying switch circuit, and the fourth contact switch (not shown) is electrically connected to a PLC and a switch of the pressure pump 22 to form a fourth electrifying switch circuit. When the valve core rod 210 is rotated to a third set position, the third fluid channel is in an on state, and the fourth fluid channel is in an off state. The contact 210a triggers the third contact switch, and the third electrifying switch circuit is turned on.

When the valve core rod 210 is rotated to a fourth set position, the fourth fluid channel is in an on state, and the third fluid channel is in an off state. The contact 210a triggers the fourth contact switch, and the fourth electrifying switch circuit is turned on. The PLC, the third electrifying switch circuit, and the fourth electrifying switch circuit are parallel switch circuits.

In the example, the combination of the first control valve and the second control valve is: the first control is an electrically controlled three-way solenoid valve 21, and the second control valve is the second two-way integrated control valve which is ganged and integrates the water outlet valve 2501 which discharges water and the reflux valve 29 which is communicated with the purge water tank 27.

As shown in FIGS. 2, 3, 4, 5, and 9, a seawater desalination method of the seawater desalination device in operation and during downtime in the invention, the method comprising:

1) when the seawater needs to be desalinated, the first three-way solenoid valve 2102 is turned on, thus a first inlet channel is in an on state, and simultaneously the second inlet channel is in an off state; the seawater is allowed to flow in the pressure pump 22 via the first inlet channel;

2) the pressure pump 22 is allowed to constantly pump the seawater to the reverse osmosis membrane assembly 23 to produce fresh water; the freshwater is distributed to two paths from a freshwater outlet of the reverse osmosis membrane assembly 23; one path is communicated with the freshwater outlet valve 25′ and is discharged from the freshwater outlet valve; and the other path is communicated with the liquid level valve 26 and is allowed to enter the purge water tank 27; the concentrated seawater produced during the filtration passes through the pressure regulating valve 24 and the water outlet valve 2501, and is discharged from the concentrated seawater outlet;

3) when the seawater desalination device is turned off as the desalination is finished, the first three-way solenoid valve 2102 is turned off, meanwhile the PLC is actuated, thus the second inlet channel is in an on state, and the first inlet channel is in an off state; the freshwater in the purge water tank 27 is allowed to flow to the pressure pump 22 via the second inlet channel; the pressure pump 22 is controlled by the PLC, and the PLC sets time to turn off the pressure pump;

4) the freshwater in the purge water tank 27 is pumped to the reverse osmosis membrane assembly 23 via the pressure pump 22 to replace the seawater in the reverse osmosis membrane assembly 23; and the replaced seawater passes through the pressure regulating valve 24 and the water outlet valve 2501, and is discharged from the concentrated seawater outlet.

As shown in FIGS. 2, 3, 4, 5, and 9, a method for cleaning the reverse osmosis membrane assembly 23 of the seawater desalination device after long-term service using detergent, the method comprising:

1) when the reverse osmosis membrane assembly 23 needs to be cleaned by detergent, the detergent is added to the purge water tank 27; the first three-way solenoid valve 2102 is turned off, thus the second inlet channel is in an on state, the detergent in the purge water tank 27 is allowed to flow in the pressure pump 22; the first inlet channel is in an off state, thus preventing the seawater from entering in; meanwhile, the valve core rod 210 is rotated to a fourth set position, the fourth fluid channel is in an on state, and the third fluid channel is in an off state; the contact 210a triggers the fourth contact switch, and the fourth electrifying switch circuit is turned on;

2) the pressure pump 22 is controlled by the PLC of the fourth electrifying switch circuit, and the PLC sets time to turn off the pressure pump; during an operation of the pressure pump 22, the detergent in the purge water tank 27 is allowed to enter the pressure pump 22 through the second inlet channel of the first three-way solenoid valve 2102, and then the detergent is pumped to the reverse osmosis membrane assembly 23 from the pressure pump 22 to clean the reverse osmosis membrane assembly 23; then the detergent passes through the reflux valve 29 and is allowed to return back to the purge water tank 27; the above process is repeated to clean the reverse osmosis membrane assembly 23;

3) when the set time of the PLC of the fourth electrifying switch circuit is over, the valve core rod 210 is rotated to a third set position, thus the third fluid channel is in an on state, and the fourth fluid channel is in an off state; the contact 210a triggers the third contact switch, and the third electrifying switch circuit is turned on;

4) the pressure pump 22 is then controlled by the PLC of the third electrifying switch circuit, and the PLC sets time to turn off the pressure pump; during an operation of the pressure pump 22, the detergent in the purge water tank 27 is allowed to enter the pressure pump 22 via the second inlet channel of the first three-way solenoid valve 2102, and then the detergent is pumped to the reverse osmosis membrane assembly 23 from the pressure pump 22; the detergent passes through the reverse osmosis membrane assembly 23 and the pressure regulating valve 24, and is discharged from the water outlet valve 2501.

### EXAMPLE 4

As shown in FIGS. 2, 3, 4, 5, and 10, a seawater desalination device comprises a seawater introducing and filtering device 10 and a seawater reverse osmosis filtering device 20.

As shown in FIG. 2, the seawater introducing and filtering device comprises a seawater inlet valve 11, a seawater pump 12, and a precise filter assembly 13. An end of the seawater inlet valve 11 is connected to a seawater inlet, and another end of the seawater inlet valve 11 is connected to the seawater pump 12. An outlet end of the seawater pump 12 is connected to the precise filter assembly 13. An outlet of the precise filter assembly 13 is connected to a water inlet valve 2101.

As shown in FIGS. 3, 4, and 10, the water inlet valve 2101 and the purge valve 28 are integrated to from a first two-way integrated control valve which is ganged. The water inlet valve 2101 comprises a first fluid channel, and the purge valve 28 comprises a second fluid channel. The first fluid channel and the second fluid channel are coordinated with and simultaneously rotated with a valve core rod 210. The valve core rod 210 comprises a contact 210a, and the contact 210a is corresponding to a first contact switch 211 and a second contact switch (not shown) which are disposed at different positions, respectively. The first contact switch is electrically connected to a switch of the pressure pump 22 to form a first electrifying switch circuit, and the second contact switch is electrically connected to a time controller 210 and a switch of the pressure pump 22 to form a second electrifying switch circuit.

When the valve core rod 210 is rotated to a first set position, the first fluid channel is in an on state, and the second fluid channel is in an off state. The contact 210a triggers the first contact switch 211, and the first electrifying switch circuit is turned on. When the valve core rod 210 is rotated to a second set position, the second fluid channel is in an on state, and the first fluid channel is in an off state. The contact 210a triggers the second contact switch 212, and the second electrifying switch circuit is turned on.

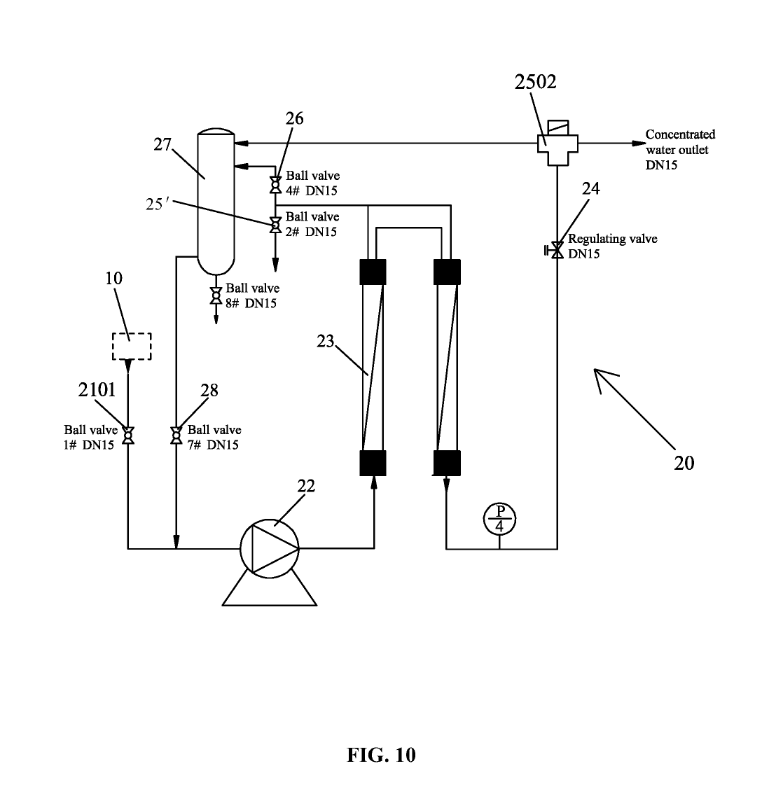

As shown in FIG. 10, a second three-way solenoid valve 2502 is disposed on a rear line of the pressure regulating valve 24 in the seawater reverse osmosis filtering device. A first inlet of the second three-way solenoid valve 2502 is communicated with the pressure regulating valve 24. A first outlet of the second three-way solenoid valve 2502 is communicated with a concentrated seawater outlet in the seawater reverse osmosis filtering device 20. A second outlet of the second three-way solenoid valve 2502 is connected to the inlet of the purge water tank 27 in the seawater reverse osmosis filtering device. The seawater desalination device further comprises a control circuit.

In the example, the first control circuit comprises a first two-way integrated control valve, a second three-way solenoid valve 2502, a pressure pump 22, and an off-delay controller or a PLC (not shown). The first two-way integrated control valve, a second three-way solenoid valve 2502, a pressure pump 22, and an off-delay controller or a PLC (not shown) are parallel.

In the example, the second control circuit is a parallel switch circuit comprising a first electrifying switch circuit and a second electrifying switch circuit.

In the example, the first control valve is a manual integrated control valve which is ganged and integrates a water inlet valve 2101 and a purge valve 28, and the second control valve is an electrically controlled two-position three-way solenoid valve 25.

As shown in FIGS. 2, 3, 4, 5, and 10, a seawater desalination method of the seawater desalination device in operation and during downtime in the invention, the method comprising:

1) when the seawater needs to be desalinated, the valve core rod 210 of the first two-way integrated control valve is rotated to a first set position, thus the first fluid channel is in an on state, and simultaneously the second fluid channel is in an off state; the contact 210a triggers the first contact switch 211, and the first electrifying switch circuit is turned on;

2) the pressure pump 22 is allowed to constantly pump the seawater to the reverse osmosis membrane assembly 23 to produce fresh water; the freshwater is distributed to two paths from a freshwater outlet of the reverse osmosis membrane assembly 23; one path is communicated with the freshwater outlet valve 25′ and is discharged from the freshwater outlet valve; and the other path is communicated with the liquid level valve 26 and is allowed to enter the purge water tank 27; the concentrated seawater produced during the filtration passes through the first outlet channel of the second three-way solenoid valve 2502 and is discharged from the concentrated seawater outlet;

3) when the seawater desalination device is turned off as the desalination is finished, the valve core rod 210 of the first two-way integrated control valve is rotated to a second set position, thus the second fluid channel is in an on state, and the first fluid channel is in an off state; the contact 210a triggers the second contact switch 212, and the second electrifying switch circuit is turned on;

4) the pressure pump 22 is controlled by the time controller 213 of the second electrifying switch circuit or the PLC, and the time controller or the PLC sets time to turn off the pressure pump; during an operation of the pressure pump 22, the freshwater in the purge water tank 27 is allowed to enter the pressure pump 22 via the purge valve 28, and then the freshwater is pumped to the reverse osmosis membrane assembly 23 from the pressure pump 22 to replace the seawater in the reverse osmosis membrane assembly 23; and the replaced seawater passes through the pressure regulating valve 24 and the first outlet channel of the second three-way solenoid valve 2502, and is discharged from the concentrated seawater outlet;

As shown in FIGS. 2, 3, 4, 5, and 10, a method for cleaning the reverse osmosis membrane assembly 23 of the seawater desalination device after long-term service using detergent, the method comprising:

1) when the reverse osmosis membrane assembly 23 needs to be cleaned by detergent, the detergent is added to the purge water tank 27; the valve core rod 210 of the first two-way integrated control valve is rotated to a second set position, thus the second fluid channel is in an on state, and the first fluid channel is in an off state; meanwhile, the second three-way solenoid valve 2502 is turned on, and the pressure pump 22 and the time controller 213 or PLC are actuated, thus the second outlet channel of the second three-way solenoid valve 2502 is in an on state, and the first outlet channel is in an off state, preventing the detergent from being discharged;

2) the detergent in the purge water tank 27 is pumped to the reverse osmosis membrane assembly 23 via the pressure pump 22; then the detergent passes through the pressure regulating valve 24 and the second outlet channel of the second three-way solenoid valve 2502, and is allowed to return back to the purge water tank 27; the detergent then is allowed to enter the pressure pump 22 via the purge valve 28 to repeat the cleaning of the reverse osmosis membrane assembly 23;

3) the time controller or the PLC operates to control the second three-way solenoid valve 2502, and the time controller or the PLC sets time to turn off the second three-way solenoid valve; the second outlet channel of the second three-way solenoid valve 2502 is in an off state, thus the cyclic cleaning is stopped; the detergent passes through the first outlet channel of the second three-way solenoid valve 2502 and is discharged from the concentrated seawater outlet; again the time controller or the PLC operates to control the pressure pump 22, and sets time to turn off the pressure pump.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A seawater desalination device, comprising:
a) a seawater introducing and filtering device;
b) a seawater reverse osmosis filtering device, the seawater reverse osmosis filtering device comprising a first control valve and a second control valve; and
c) a control circuit;
wherein
the seawater introducing and filtering device is connected to the first control valve of the seawater reverse osmosis filtering device;
the second control valve is disposed at a terminal pipe of the seawater reverse osmosis filtering device; and
the control circuit is adapted to control operation of the seawater reverse osmosis filtering device.

2. The device of claim 1, wherein
the seawater introducing and filtering device comprises: a seawater inlet valve, a seawater pump, and a precise filter assembly connected in that order via pipelines;
the seawater reverse osmosis filtering device comprises: the first control valve, a pressure pump, a reverse osmosis membrane assembly, a pressure regulating valve, the second control valve, and a purge water tank connected in that order via pipelines;
one end of the seawater inlet valve of the seawater introducing and filtering device is connected to a seawater inlet, and the other end of the seawater inlet valve is connected to the seawater pump; an outlet end of the seawater pump is connected to the precise filter assembly, and an outlet of the precise filter assembly is connected to the first control valve; and
the first control valve of the seawater introducing and filtering device is connected to the pressure pump, and the pressure pump is connected to a water inlet of the reverse osmosis membrane assembly; a freshwater outlet of the reverse osmosis membrane assembly is divided into two paths, one path is connected to a freshwater outlet valve, and the other path is connected to a purge water tank via a liquid level valve; the reverse osmosis membrane assembly further comprises a concentrated seawater outlet, and the concentrated seawater outlet is connected to the pressure regulating valve and second control valve; and the purge water tank is connected to a water inlet of the pressure pump via the first control valve.

3. The device of claim 1, wherein a first inlet of the first control valve communicates with an end of the seawater introducing and filtering device; a second inlet of the first control valve communicates with an output pipe of a purge water tank of the seawater reverse osmosis filtering device; and an outlet of the first control valve communicates with an inlet of a pressure pump of the seawater reverse osmosis filtering device.

4. The device of claim 3, wherein the first control valve comprises a first three-way solenoid valve; a first inlet of the first three-way solenoid valve communicates with the end of the seawater introducing and filtering device; a second inlet of the first three-way solenoid valve communicates with the output pipe of the purge water tank of the seawater reverse osmosis filtering device; and an outlet of the first three-way solenoid valve communicates with the inlet of the pressure pump of the seawater reverse osmosis filtering device.

5. The device of claim 3, wherein
the seawater reverse osmosis filtering device further comprises a purge valve connected to the purge water tank; the first control valve is a first two-way integrated control valve comprising a water inlet valve and the purge valve; a first fluid channel is arranged in the water inlet valve, and a second fluid channel is arranged in the purge valve; the first fluid channel and the second fluid channel cooperate with a valve core rod of the first two-way integrated control valve by synchronous rotation; a contact is arranged on the valve core rod corresponding to a first contact switch and a second contact switch of different positions; the first contact switch and a switch of the pressure pump are in electric connection and form a first electrifying switch circuit; and the second contact switch, a time controller, and the switch of the pressure pump are in electric connection and form a second electrifying switch circuit; and
when rotating the valve core rod to a first set position, the first fluid channel is in an open state while the second fluid channel is in a closed state, and the contact triggers the first contact switch to connect the first electrifying switch circuit; and when rotating the valve core rod to a second set position, the second fluid channel is in the open state while the first fluid channel is in the closed state, and the contact triggers the second contact switch to connect the second electrifying switch circuit.

6. The device of claim 1, wherein an inlet of the second control valve communicates with a pressure regulating valve of the seawater reverse osmosis filtering device; a first outlet of the second control valve communicates with a concentrated water outlet of the seawater reverse osmosis filtering device; and a second outlet of the second control valve communicates with an inlet of a purge water tank of the seawater reverse osmosis filtering device.

7. The device of claim 6, wherein the second control valve comprises a second three-way solenoid valve; an inlet of the second three-way solenoid valve communicates with the pressure regulating valve of the seawater reverse osmosis filtering device; a first outlet of the second three-way solenoid valve communicates with the concentrated water outlet of the seawater reverse osmosis filtering device; and a second outlet of the second three-way solenoid valve communicates with the inlet of the purge water tank of the seawater reverse osmosis filtering device.

8. The device of claim 6, wherein
the second control valve is a second two-way integrated control valve comprising a reflux valve and a water outlet valve; the reflux valve is arranged behind the pressure regulating valve in a water flow direction and communicates with the purge water tank; a third fluid channel is arranged in the water outlet valve, and a fourth fluid channel is arranged in the reflux valve; the third fluid channel and the fourth fluid channel cooperate with a valve core rod of the second two-way integrated control valve by synchronous rotation; a contact is arranged on the valve core rod corresponding to a third contact switch and a fourth contact switch of different positions; the third contact switch, a time controller, and a switch of the pressure pump are in electric connection and form a third electrifying switch circuit; and the fourth contact switch, the time controller, and the switch of the pressure pump are in electric connection and form a fourth electrifying switch circuit; and
when rotating the valve core rod to a third set position, the third fluid channel is in an open state while the fourth fluid channel is in a closed state, and the contact triggers the third contact switch to connect the third electrifying switch circuit; and when rotating the valve core rod to a fourth set position, the fourth fluid channel is in the open state while the third fluid channel is in the closed state, and the contact triggers the fourth contact switch to connect the fourth electrifying switch circuit.

9. The device of claim 1, wherein
the first control valve and the second control valve are selected from one of the following combinations:
1) both the first control valve and the second control valve are electrically controlled three-way solenoid valves;
2) the first control valve is a manual two-position three-way valve, and the second valve is the electrically controlled three-way solenoid valve;
3) the first control valve is the electrically controlled three-way solenoid valve, and the second control valve is the manual two-position three-way valve;
4) both the first control valve and the second control valve are manual two-position three-way valves;
5) both the first control valve and the second control valve are pneumatically controlled two-position three-way valves;
6) the first control valve is the manual two-position three-way valve, and the second control valve is the pneumatically controlled two-position three-way valve;
7) the first control valve is the pneumatically controlled two-position three-way valve, and the second control valve is the manual two-position three-way valve;
8) the first control valve is the electrically controlled three-way solenoid valve, and the second control valve is the pneumatically controlled two-position three-way valve;
9) the first control valve is the pneumatically controlled two-position three-way valve, and the second control valve is the electrically controlled two-position three-way solenoid valve;
10) the first control valve is a manual type first two-way integrated control valve comprising the water inlet valve and the purge valve, and the second control valve is the electrically controlled three-way solenoid valve;
11) the first control valve is the electrically controlled three-way solenoid valve, and the second control valve is a manual type second two-way integrated control valve comprising the water outlet valve and the reflux valve communicating with the purge water tank;
12) the first control valve is the manual type first two-way integrated control valve comprising the water inlet valve and the purge valve, and the second control valve is the manual two-position three-way valve;
13) the first control valve is the manual two-position three-way valve, and the second control valve is the manual type second two-way integrated control valve comprising the water outlet valve and the reflux valve communicating with the purge water tank;
14) the first control valve is the manual type first two-way integrated control valve comprising the water inlet valve and the purge valve, and the second control valve is the pneumatically controlled two-position three-way valve; and
15) the first control valve is the pneumatically controlled two-position three-way valve, and the second control valve is the manual type second two-way integrated control valve comprising the water outlet valve and the reflux valve communicating with the purge water tank.

10. The device of claim 4, wherein the control circuit comprises related circuits connected in parallel for controlling the first control valve, the second control valve, the pressure pump, and an off-delay controller or a programmable logic controller (PLC).

11. The device of claim 5, wherein the control circuit is a switch circuit comprising the first electrifying switch circuit, the second electrifying switch circuit, the third electrifying switch circuit, and the fourth electrifying switch circuit connected in parallel.

12. The device of claim 5, wherein the time controller is a time relay or a microcontroller unit (MCU).

13. A seawater desalination device, comprising:
a) a seawater introducing and filtering device, the seawater introducing and filtering device comprising: a seawater inlet valve, a seawater pump, and a precise filter assembly connected in that order via pipelines; and
b) a seawater reverse osmosis filtering device, the seawater reverse osmosis filtering device comprising: a first control valve, a pressure pump, a reverse osmosis membrane assembly, a pressure regulating valve, a second control valve, and a purge water tank connected in that order via pipelines; and
c) a control circuit;
wherein
the seawater introducing and filtering device is connected to the first control valve of the seawater reverse osmosis filtering device; and the first control valve is a first three-way solenoid valve; a first inlet of the first three-way solenoid valve communicates with an end of the seawater introducing and filtering device; a second inlet of the first three-way solenoid valve communicates with an output pipe of the purge water tank of the seawater reverse osmosis filtering device; an outlet of the first three-way solenoid valve communicates with an inlet of a pressure pump of the seawater reverse osmosis filtering device; and
the control circuit is adapted to control operation of the seawater reverse osmosis filtering device.

14. The device of claim 13, wherein the second control valve arranged on a pipe behind the pressure regulating valve of the seawater reverse osmosis filtering device in a water flow direction is a second three-way solenoid valve; an inlet of the second three-way solenoid valve communicates with the pressure regulating valve of the seawater reverse osmosis filtering device; a first outlet of the second three-way solenoid valve communicates with the concentrated water outlet of the seawater reverse osmosis filtering device; and a second outlet of the second three-way solenoid valve communicates with an inlet of the purge water tank of the seawater reverse osmosis filtering device.

15. A seawater desalination device, comprising:
a) a seawater introducing and filtering device, the seawater introducing and filtering device comprising: a seawater inlet valve, a seawater pump, and a precise filter assembly connected in that order via pipelines;
b) a seawater reverse osmosis filtering device, the seawater reverse osmosis filtering device comprising: a first control valve, a pressure pump, a reverse osmosis membrane assembly, a pressure regulating valve, a second control valve, and a purge water tank connected in that order via pipelines; and
c) a control circuit;
wherein
the second control valve arranged on a pipe behind the pressure regulating valve of the seawater reverse osmosis filtering device in a water flow direction is a second three-way solenoid valve; an inlet of the second three-way solenoid valve communicates with the pressure regulating valve of the seawater reverse osmosis filtering device; a first outlet of the second three-way solenoid valve communicates with the concentrated water outlet of the seawater reverse osmosis filtering device; a second outlet of the second three-way solenoid valve communicates with an inlet of the purge water tank of the seawater reverse osmosis filtering device; and the control circuit is adapted to control operation of the seawater reverse osmosis filtering device.

16. The device of claim 15, wherein
the seawater introducing and filtering device is connected to the first control valve of the seawater reverse osmosis filtering device; the first control valve is a first three-way solenoid valve; a first inlet of the first three-way solenoid valve communicates with an end of the seawater introducing and filtering device; a second inlet of the first three-way solenoid valve communicates with an output pipe of the purge water tank of the seawater reverse osmosis filtering device; an outlet of the first three-way solenoid valve communicates with an inlet of a pressure pump of the seawater reverse osmosis filtering device.

17. A method for desalinating seawater using the device of claim 1, the first control valve of the seawater desalination device being a first two-way integrated control valve comprising a water inlet valve and a purge valve; a first fluid channel being arranged in the water inlet valve, and a second fluid channel being arranged in the purge valve; the first fluid channel and the second fluid channel cooperating with a valve core rod of the first two-way integrated control valve by synchronous rotation; a contact being arranged on the valve core rod corresponding to a first contact switch and a second contact switch of different positions; the first contact switch and a switch of a pressure pump being in electric connection and form a first electrifying switch circuit; and the second contact switch, a time controller, and the switch of the pressure pump being in electric connection and form a second electrifying switch circuit; and the method comprising:
1) rotating a valve core rod of the first two-way integrated control valve to a first set position to make the first fluid channel in an open state and the second fluid channel synchronously in a closed state, whereby allowing the contact to trigger the first contact switch to connect the first electrifying switch circuit;
2) continuously pumping the seawater by the pressure pump to the reverse osmosis membrane assembly for preparing freshwater, discharging the prepared freshwater from a freshwater outlet of the reverse osmosis membrane assembly in two paths, and allowing one path of the freshwater to pass through a freshwater outlet valve and then discharging the path of the freshwater for use, and allowing the other path of the freshwater to pass through a liquid level valve and reach a purge water tank; and allowing a concentrated seawater produced from filtration to pass through a pressure regulating valve and discharging the concentrated seawater via a water outlet valve;
3) when the seawater desalination is finished and the seawater desalination device is to be stopped, rotating the valve core rod of the first two-way integrated control valve to a second set position to make the second fluid channel in the open state and the first fluid channel in the closed state, whereby allowing the contact to trigger the second contact switch to connect the second electrifying switch circuit; and
4) controlling a pressure pump to operate for a set time by a time controller of the second electrifying switch circuit, whereby introducing the freshwater of the purge water tank via the purge valve to the pressure pump, pumping the freshwater to the reverse osmosis membrane assembly from the pressure pump for replacing the seawater in the reverse osmosis membrane assembly, and discharging replaced seawater via the pressure regulating valve and the water outlet valve.

18. A method for cleaning the seawater desalination device of claim 1, the first control valve of the seawater desalination device being a first two-way integrated control valve comprising a water inlet valve and a purge valve; a first fluid channel being arranged in the water inlet valve, and a second fluid channel being arranged in the purge valve; the first fluid channel and the second fluid channel cooperating with a valve core rod of the first two-way integrated control valve by synchronous rotation; the second control valve being a second two-way integrated control valve comprising a reflux valve and a water outlet valve; the reflux valve being arranged behind the pressure regulating valve in a water flow direction and communicates with a purge water tank; a third fluid channel being arranged in the water outlet valve, and a fourth fluid channel being arranged in the reflux valve; the third fluid channel and the fourth fluid channel cooperating with a valve core rod of the second two-way integrated control valve by synchronous rotation; and the method comprising:
1) when the reverse osmosis membrane assembly requires cleaning, adding a detergent to a purge water tank, disconnecting a first three-way solenoid valve, rotating a valve core rod of a first two-way integrated control valve to a second set position to make a second fluid channel in an open state and a first fluid channel in a closed state; in the meanwhile, rotating a valve core rod of a second two-way integrated control valve to a fourth set position to make the fourth fluid channel in the open state and the third fluid channel in the closed state and to trigger a fourth contact switch to connect a fourth electrifying switch circuit by a contact;
2) controlling the pressure pump to operate for a set time by a time controller of the fourth electrifying switch circuit, during which, introducing the detergent of the purge water tank to the pressure pump via a purge valve, pumping the detergent by the pressure pump to the reverse osmosis membrane assembly for cleaning the reverse osmosis membrane assembly, and refluxing the detergent from the reverse osmosis membrane assembly to the purge tank, thus realizing repeated cycles of cleaning of the reverse osmosis membrane assembly;
3) when the set time of the time controller in the fourth electrifying switch circuit is reached, rotating the valve core rod of the second two-way integrated control valve to a third set position to make the third fluid channel in the open state and the fourth fluid channel in the closed state and to trigger a third contact switch to connect a third electrifying switch circuit by a contact; and
4) controlling the pressure pump to operate for a set time by the time controller of the third electrifying switch circuit, during which, introducing the detergent of the purge water tank to the pressure pump via a purge valve, pumping the detergent by the pressure pump to the reverse osmosis membrane assembly, and discharging the detergent via the pressure regulating valve and a water outlet valve.

19. A method for desalinating seawater using the seawater desalination device of claim 1, the first control valve being a first three-way solenoid valve, and the second control valve being a second three-way solenoid valve; and the method comprising:
1) when desalinating the seawater, starting a first three-way solenoid valve to make a first inlet channel in an open state and a second inlet channel synchronously in a closed state, whereby allowing the seawater to pass through the first inlet channel to a pressure pump; in the meanwhile, making the second three-way solenoid valve in a halt state, and making a first outlet channel of the second three-way solenoid valve in an open state and a second outlet channel thereof in a closed state;
2) starting the pressure pump, continuously pumping the seawater by the pressure pump to a reverse osmosis membrane assembly to prepare freshwater; discharging the prepared freshwater from a freshwater outlet of the reverse osmosis membrane assembly in two paths, and allowing one path of the freshwater to pass through a freshwater outlet valve and then discharging the path of the freshwater for use, and allowing the other path of the freshwater to pass through a liquid level valve and reach a purge water tank; and allowing a concentrated seawater produced from filtration to pass through a pressure regulating valve and discharging the concentrated seawater via the first outlet channel of the second three-way solenoid valve and a concentrated water outlet;
3) when the seawater desalination is finished and the seawater desalination device is to be stopped, disconnecting the first three-way solenoid valve and at the same time allowing a time controller to operate, and allowing the second inlet channel to be in the open state and the first inlet channel to be in the closed state, and introducing the freshwater in the purge water tank via the second inlet channel to the pressure pump; and operating the pressure pump for a set time under the control of the time controller; and
4) pumping the freshwater from the purge water tank to the reverse osmosis membrane assembly by the pressure pump, replacing the seawater in the reverse osmosis membrane assembly, and discharging replaced seawater via the pressure regulating valve, the first outlet channel of the second three-way solenoid valve, and the concentrated water outlet.

20. A method for cleaning the seawater desalination device of claim 1, the first control valve being a first three-way solenoid valve, and the second control valve being a second three-way solenoid valve; and the method comprising:
1) when the reverse osmosis membrane assembly requires cleaning, adding a detergent to a purge water tank, disconnecting a first three-way solenoid valve, opening a second inlet channel and allowing the detergent of the purge water tank to flows to a pressure pump, and closing a first inlet channel for preventing the seawater from inside; in the meanwhile, connecting a second three-way solenoid valve and starting the pressure pump and a time controller, opening a second outlet channel of the second three-way solenoid valve and closing a first outlet channel for preventing the detergent from discharging;
2) pumping the detergent of the purge water tank to the reverse osmosis membrane assembly by the pressure pump, allowing the detergent to pass through a pressure regulating valve and the second outlet channel of the second three-way solenoid valve to enter the purge water tank and the second inlet channel of the first three-way solenoid valve respectively to return to the pressure pump, thus realizing repeated cycles of cleaning of the reverse osmosis membrane assembly; and
3) disconnecting the second three-way solenoid valve at a set time by the time controller, closing the second outlet of the second three-way solenoid valve, stopping the cycles of cleaning, and discharging the detergent from a concentrated water outlet via the first outlet channel of the second three-way solenoid valve; and stopping operation of the pressure pump at a set time by the time controller.
